(19) United States
(12) Patent Application Publication
(10) Pub. No.: US 2012/0255314 A1
(43) Pub. Date: Oct. 11, 2012

(54) CRYOPUMP SYSTEM, COMPRESSOR, AND METHOD FOR REGENERATING CRYOPUMPS

(75) Inventor: Takaaki Matsui, Tokyo (JP)

(73) Assignee: SUMITOMO HEAVY INDUSTRIES, LTD., Tokyo (JP)

(21) Appl. No.: 13/437,433

(22) Filed: Apr. 2, 2012

(30) Foreign Application Priority Data
Apr. 11, 2011 (JP) 2011-087169

(51) Int. Cl. B01D 8/00; F04B 41/00

(52) U.S. Cl. 62/55.5; 417/437

(57) ABSTRACT

A cryopump system includes: a cryopump including a refrigerator for executing cooling operation for cooling a cryopanel and heating operation for regenerating the cryopanel; and a compressor for supplying operating gas to the refrigerator. The cryopump system raises the temperature of operating gas in the compressor during the heating operation than the temperature thereof during the cooling operation. The compressor may include a heat exchanger for cooling operating gas to be supplied to the refrigerator, and a bypass passage that circumvents the heat exchanger. The control unit may switch, in accordance with the operation status of the refrigerator, between a flow passage that passes through the heat exchanger and a flow passage that passes through the bypass flow passage.

### BACKGROUND OF THE INVENTION

1. Field of the Invention

### TECHNICAL FIELD

The present invention relates to a cryopump system, a compressor, and a method for regenerating a cryopump.

2. Description of the Related Art

### BACKGROUND ART

A cryopump is a vacuum pump that traps gas molecules by condensing or adsorbing them on cryopanels cooled to an ultra cold temperature so as to evacuate them. A cryopump is generally used to attain a clean vacuum environment required for a semiconductor circuit manufacturing process, or the like. A cryopump includes a refrigerator for cooling cryopanels. A compressor for supplying high pressure operating gas to the refrigerator is provided in association with the cryopump.

### SUMMARY OF THE INVENTION

An aspect of the present invention relates to a cryopump system. The cryopump system includes: a cryopump including a refrigerator configured to execute cooling operation for cooling a cryopanel and heating operation for regenerating the cryopanel; and a compressor configured to supply operating gas to the refrigerator. The cryopump system is configured to raise an operating gas temperature in the compressor during the heating operation than that during the cooling operation.

Another aspect of the present invention relates to an operating gas compressor for a cryopump or a refrigerator. The compressor is configured to raise the temperature of operating gas to be supplied during heating operation than the temperature thereof during cooling operation of the cryopump or the refrigerator.

Another aspect of the present invention is a regeneration method for a cryopump. The method includes heating a cryopanel. The heating includes raising an operating gas temperature for a refrigerator in the cryopump than that before the heating.

### BRIEF DESCRIPTION OF THE DRAWINGS

FIG. 1 schematically shows a cryopump according to an exemplary embodiment of the present invention;

FIG. 2 schematically shows a compressor according to an exemplary embodiment of the present invention;

FIG. 3 shows a flowchart for illustrating a regeneration method according to an exemplary embodiment of the present invention; and

FIG. 4 shows a flowchart for illustrating flow passage switching control in a compressor according to an exemplary embodiment of the present invention.

### DETAILED DESCRIPTION OF THE INVENTION

### Mode for Carrying out the Invention

The invention will now be described by reference to the preferred embodiments. This does not intend to limit the scope of the present invention, but to exemplify the invention.

In order to cool cryopanels, a refrigerator adiabatically expands operating gas so that cooling occurs. Therefore, operating gas to be supplied to the refrigerator is preferably at a low temperature. Thus, a compressor, which supplies operating gas, generally removes heat occurred by the compression of the operating gas and delivers the operating gas to the refrigerator, accordingly.

Known as one of the methods for heating cryopanels to regenerate a cryopump is so-called reverse-rotation heating. The reverse-rotation heating is an operating method that differentiates timings of intake and discharge of operating gas from those of the cooling operation, so as to cause adiabatic compression of the operating gas, which allows the refrigerator to heat the cryopanels. Typically, by allowing a rotary valve that determines the timings of intake and discharge of the refrigerator to rotate backward, adiabatic compression occurs.

One of exemplary purposes of an aspect of the present invention is to increase the heating capability of the reverse-rotation heating.

According to an aspect of the present invention, a cryopump system is provided. The cryopump system comprises: a cryopump comprising a refrigerator for executing cooling operation for cooling a cryopanel and heating operation for regenerating the cryopanel; and a compressor for supplying operating gas to the refrigerator. The cryopump system raises the temperature of operating gas to be supplied by the compressor during the heating operation than the temperature thereof during the cooling operation.

According to the aspect, operating gas at a comparatively high temperature can be supplied to a refrigerator in heating operation. Therefore, the heating of cryopanels can be expedited. Since heating time during a regeneration of cryopanels can be reduced, time required for the regeneration can be reduced.

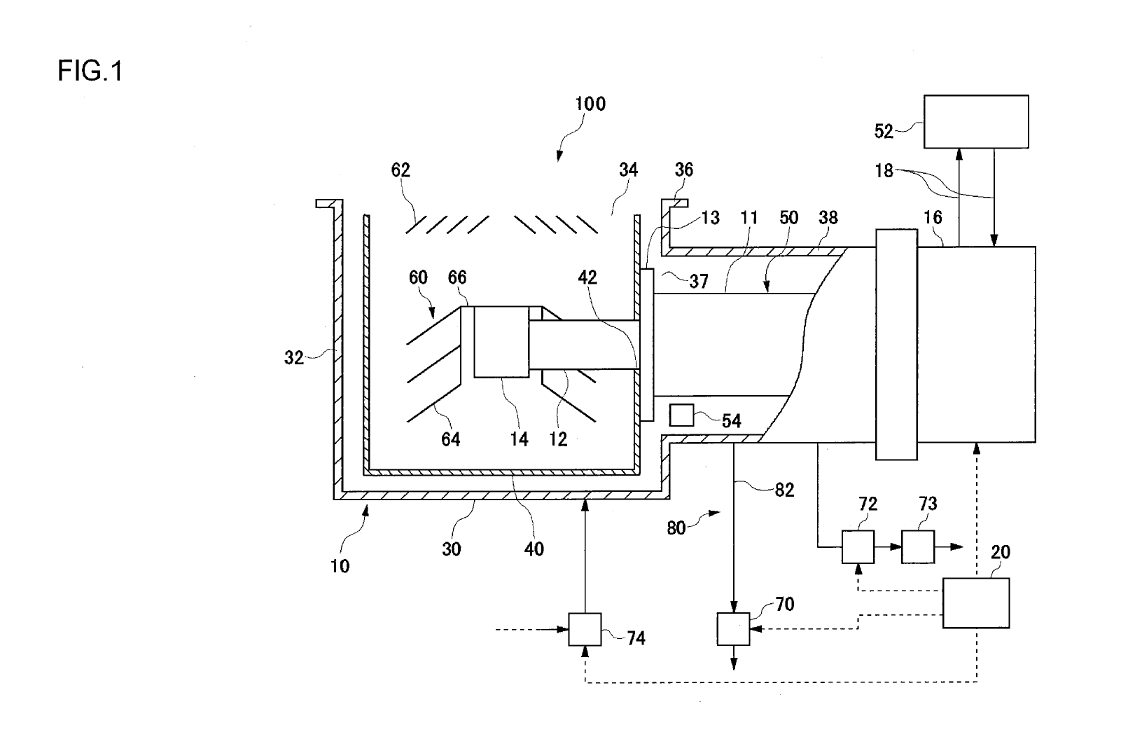

FIG. 1 schematically shows a cryopump system 100 according to an exemplary embodiment of the present invention. The cryopump system 100 comprises a cryopump 10, a control unit 20, and a compressor 52. The cryopump 10 is mounted to a vacuum chamber of, for example, an ion implantation apparatus, a sputtering apparatus, or the like and used to increase the vacuum level inside the vacuum chamber to a level required by a desired process. The cryopump 10 is configured to include a cryopump housing 30, a radiation shield 40, and a refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12.

The second cooling stage 14 is installed on the second cylinder 12 at the end that is farthest from the first cylinder 11. The refrigerator 50 shown in FIG. 1 is a two-stage refrigerator and achieves lower temperature by combining two cylinders in series. The refrigerator 50 is connected to a compressor 52 through a refrigerant pipe 18.

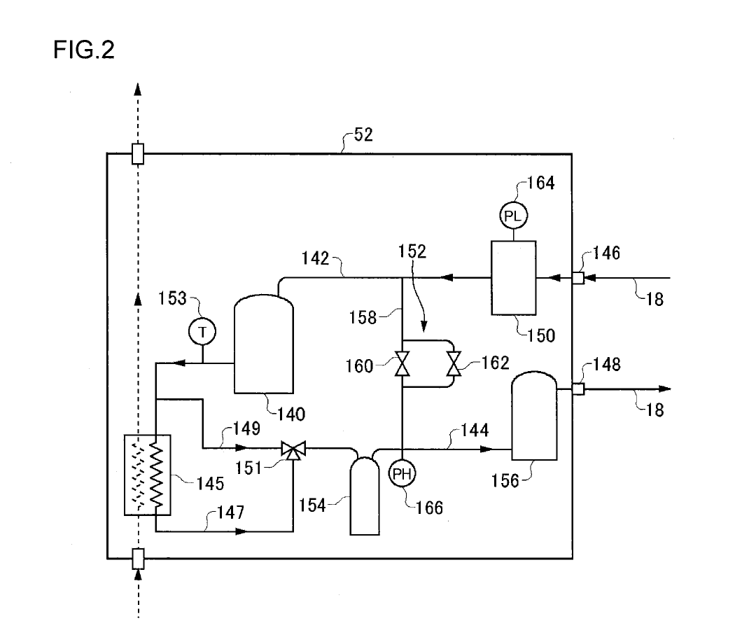

The compressor 52 compresses a refrigerant gas (i.e., an operating gas) such as helium or the like, and supplies the gas to the refrigerator 50 through the refrigerant pipe 18. The detail on the compressor 52 will be described later with reference to FIG. 2. While cooling the operating gas by allowing the gas to pass through a regenerator, the refrigerator 50 further cools the gas by expanding the gas in an expansion chamber inside the first cylinder 11 and in an expansion chamber in the second cylinder 12. The regenerator is installed inside the expansion chambers. Thereby, the first cooling stage 13 installed on the first cylinder 11 is cooled to a first cooling temperature level while the second cooling stage 14 installed on the second cylinder 12 is cooled to a second cooling temperature level lower than the first cooling temperature level. For example, the first cooling stage 13 is cooled to about 65-100 K, while the second cooling stage 14 is cooled to about 10-20 K.

The operating gas, which has absorbed heat by expanding in the respective expansion chambers and cooled the respective cooling stages, passes through the regenerator again and is returned to the compressor 52 through the refrigerant pipe 18. The flows of the operating gas from the compressor 52 to the refrigerator 50 and from the refrigerator 50 to the compressor 52 are switched by a rotary valve (not shown) in the refrigerator 50. A valve drive motor 16 rotates the rotary valve with power supplied from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor (not shown) may be provided on the first cooling stage 13 or on the second cooling stage 14. The control unit 20 may control the cooling temperature by controlling the driving frequency of the valve drive motor 16. For this purpose, the control unit 20 may comprise an inverter for controlling the valve drive motor 16. The control unit 20 may be configured so as to control the compressor 52 and respective valves, which will be described later.

The control unit 20 may comprise a cryopump controller for controlling the cryopump 10, a compressor controller for controlling the compressor 52, and an upper level controller for integrally controlling the cryopump controller and the compressor controller. The control unit 20 may be integrated with the cryopump 10, may be integrated with the compressor 52, or may be configured as a control device separate from the cryopump 10 and the compressor 52.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually in an orthogonal direction) with the axis of the cylindrical radiation shield 40. The present invention is also applicable to a so-called vertical-type cryopump in a similar way. In the vertical-type cryopump, the refrigerator is inserted along the axis of the radiation shield.

The cryopump housing 30 has a portion 32 formed into a cylindrical shape (hereinafter, referred to as a “trunk portion 32”), one end of which being provided with an opening and the other end being closed. The opening is provide as a pump inlet 34 for accepting a gas to be evacuated from the vacuum chamber of a sputtering apparatus or the like, to which the cryopump is to be connected. The pump inlet 34 is defined by the interior surface of the upper end of the trunk portion 32 of the cryopump housing 30. On the trunk portion 32, an opening 37 for inserting the refrigerator 50 is formed in addition to the pump inlet 34. One end of a cylindrically shaped refrigerator container 38 is fitted to the opening 37 on the trunk portion 32 while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted, by using the mounting flange 36, to a vacuum chamber to which the cryopump 10 is to be mounted.

The cryopump housing 30 is provided in order to separate the inside of the cryopump 10 from the outside thereof. As described above, the cryopump housing 30 is configured to include the trunk portion 32 and the refrigerator container 38, and the trunk portion 32 and the refrigerator container 38 are gastight and the respective insides thereof are maintained at a common pressure. This allows the cryopump housing 30 to function as a vacuum vessel during pumpimg operation of the cryopump 10. The exterior surface of the cryopump housing 30 is exposed to the environment outside the cryopump 10 during the operation of the cryopump 10, i.e., even during the operation of the refrigerator. Therefore the exterior surface is maintained at a temperature higher than that of the radiation shield 40. The temperature of the cryopump housing 30 is typically maintained at an ambient temperature. Hereinafter, the ambient temperature refers to a temperature of a place where the cryopump 10 is installed or a temperature close to the temperature. The ambient temperature may be, for example, at or around room temperature.

A pressure sensor 54 is provided in the refrigerator container 38 of the cryopump housing 30. The pressure sensor 54 periodically measures the internal pressure of the refrigerator container 38, i.e., the pressure in the cryopump housing 30 and outputs a signal indicating the measured pressure to the control unit 20. The pressure sensor 54 is connected to the control unit 20 so that the output signals can be communicated. Alternatively, the pressure sensor 54 may be provided in the trunk portion 32 of the cryopump housing 30.

The pressure sensor 54 has a wide measurement range including both a high vacuum level attained by the cryopump 10 and the atmospheric pressure level. It is desirable that at least a pressure range, which can occur during a regeneration process, is included in the measurement range. In the present embodiment, it is preferable to use, for example, a crystal gauge as the pressure sensor 54. The crystal gauge refers to a sensor that measures a pressure by using a phenomenon in which the oscillation resistance of a crystal oscillator varies with a pressure. Alternatively, the pressure sensor 54 may be a Pirani gauge. A pressure sensor for measuring a vacuum level and a pressure sensor for measuring an atmospheric pressure level may be provided in the cryopump 10, separately.

A vent valve 70, a rough valve 72 and a purge valve 74 are connected to the cryopump housing 30. The opening/closing of each of the vent valve 70, the rough valve 72, and the purge valve 74 are controlled by the control unit 20.

The vent valve 70 is provided, for example, at the end of an exhaust line 80. Alternatively, the vent valve 70 may be provided at the middle of the exhaust line 80 and a tank or the like for collecting released fluid may be provided at the end of the exhaust line 80. By opening the vent valve 70, the flow of fluid in the exhaust line 80 is permitted, and by closing the vent valve 70, the flow of fluid in the exhaust line 80 is blocked. Although the fluid to be exhausted is basically gas, the fluid may be liquid or a mixture of gas-liquid. For example, liquefied gas that has been condensed by the cryopump 10 may be mixed with the fluid to be exhausted. By allowing the vent valve 70 to open, the positive pressure occurred in the cryopump housing 30 can be released to the outside.

The exhaust line 80 includes an exhaust duct 82 for exhausting fluid from the internal space of the cryopump 10 to an external environment. The exhaust duct 82 is, for example, connected to the refrigerator container 38 of the cryopump housing 30. Although the exhaust duct 82 is a duct having a circular cross section orthogonal to the direction of the flow, the exhaust duct 82 may have a cross section of any other shapes. The exhaust line 80 may include a filter for removing foreign bodies from the fluid to be exhausted through the exhaust duct 82. The filter may be provided upstream from the vent valve 70 in the exhaust line 80.

The vent valve 70 is configured to also function as a so-called safety valve. The vent valve 70 is, for example, a normally closed type control valve that is provided in the exhaust duct 82. Further, the strength of a force required to close the vent valve 70 is defined in advance so that the vent valve 70 opens mechanically when being subject to a predetermined differential pressure. The predetermined differential pressure can be set as appropriate by, for example, taking into consideration the internal pressure that can be exerted upon the cryopump housing 30, the structural durability of the cryopump housing 30, or the like. Since the external environment of the cryopump 10 is normally at an atmospheric pressure, the predetermined differential pressure is set to a predetermined value relative to the atmospheric pressure.

The vent valve 70 is typically opened by the control unit 20 when fluid is released from the cryopump 10, for example, during the regeneration process. When fluid should not be released, the vent valve 70 is closed by the control unit 20. On the other hand, the vent valve 70 is mechanically opened when the defined differential pressure is exerted thereupon. As a result, when the internal pressure of the cryopump rises too high for some reasons, the vent valve 70 is opened mechanically without requiring control. Thereby, the internal high pressure can be released. In this manner, the vent valve 70 functions as a safety valve. Combining the vent valve 70 with a safety valve in this way leads to advantages of cost reduction and space saving in comparison with a case where two valves are separately provided.

The rough valve 72 is connected to a rough pump 73. Opening of the rough valve 72 opens a passage between the rough pump 73 and the cryopump 10, while closing of the rough valve 72 blocks the passage. The rough pump 73 is typically provided as a vacuum apparatus separate from the cryopump 10, and forms, for example, a part of a vacuum system including a vacuum chamber to which the cryopump 10 is connected. By operating the rough pump 73 with the rough valve 72 open, the pressure inside the cryopump 10 is reduced.

The purge valve 74 is connected to a purge gas supply device (not shown). The purge gas is, for example, a nitrogen gas. The control unit 20 controls the purge valve 74, thereby the supply of the purge gas to the cryopump 10 is controlled.

The radiation shield 40 is arranged inside the cryopump housing 30. The radiation shield 40 is formed as a cylindrical shape, one end of which being provided with an opening and the other end being closed, that is, a cup-like shape. The radiation shield 40 may be formed as a one-piece cylinder as illustrated in FIG. 1. Alternatively, a plurality of parts may form a cylindrical shape as a whole. The plurality of parts may be arranged so as to have a gap between one another.

The trunk portion 32 of the cryopump housing 30 and the radiation shield 40 are both formed as substantially cylindrical shapes and are arranged concentrically. The inner diameter of the trunk portion 32 of the cryopump housing 30 is larger than the outer diameter of the radiation shield 40 to some extent.

Therefore, the radiation shield 40 is arranged in the cryopump housing 30 without contact, spaced reasonably apart from the interior surface of the trunk portion 32 of the cryopump housing 30. That is, the outer surface of the radiation shield 40 faces the inner surface of the cryopump housing 30. The shapes of the trunk portion 32 of the cryopump housing 30 and the radiation shield 40 are not limited to cylindrical but may be tubes having a rectangular or elliptical cross section, or any other cross section. Typically, the shape of the radiation shield 40 is analogous to the shape of the interior surface of the trunk portion 32 of the cryopump housing 30.

The radiation shield 40 is provided as a radiation shield to protect both the second cooling stage 14 and a low temperature cryopanel 60, which is thermally connected to the second cooling stage 14, from radiation heat mainly from the cryopump housing 30. The second cooling stage 14 is arranged inside the radiation shield 40, substantially on the central axis of the radiation shield 40. The radiation shield 40 is fixed to the first cooling stage 13 so as to be thermally connected to the stage 13, and the radiation shield 40 is cooled to a temperature comparable to that of the first cooling stage 13.

The low temperature cryopanel 60 includes, for example, a plurality of panels 64. Each of the panels 64 has a shape of the side surface of a truncated cone, i.e., an umbrella-like shape. Each panel 64 is attached to a panel mounting member 66 that is fixed to the second cooling stage 14. Typically, an adsorbent (not shown) such as charcoal or the like is provided on each panel 64. The adsorbent is adhered to, for example, the back face of the panel 64. The plurality of the panels 64 is attached to the panel mounting member 66 with spaces between one another. The plurality of the panels 64 is arranged in the direction from the pump inlet 34 toward the cryopump inside.

A baffle 62 is provided in the inlet of the radiation shield 40 in order to protect both the second cooling stage 14 and the low temperature cryopanel 60, which is thermally connected to the stage, from radiation heat emitted from a vacuum chamber or the like. The baffle 62 is formed as, for example, a louver structure or a chevron structure. The baffle 62 may be formed as circular shapes concentrically arranged around the central axis of the radiation shield 40 or may be formed in another shape such as a lattice or the like. The baffle 62 is mounted at the opening end of the radiation shield 40 and cooled to a temperature comparable to that of the radiation shield 40.

A refrigerator mounting opening 42 is formed on the side surface of the radiation shield 40. The refrigerator mounting opening 42 is formed on the side surface of the radiation shield 40 at the middle in the central axis of the radiation shield 40. The refrigerator mounting opening 42 of the radiation shield 40 is provided coaxially with the opening 37 of the cryopump housing 30. The second cylinder 12 and the second cooling stage 14 of the refrigerator 50 are inserted through the refrigerator mounting opening 42 in the direction perpendicular to the central axis of the radiation shield 40. The radiation shield 40 is fixed to the first cooling stage 13 so as to be thermally connected to the stage, at the refrigerator mounting opening 42.

As an alternative to the direct mounting of the radiation shield 40 to the first cooling stage 13, the radiation shield 40 may be mounted to the first cooling stage 13 by a connecting sleeve. The sleeve is, for example, a heat transfer member for surrounding one end of the second cylinder 12 towards the first cooling stage 13 and for thermally connecting the radiation shield 40 to the first cooling stage 13.

FIG. 2 schematically shows the compressor 52 according to an exemplary embodiment of the present invention. The compressor 52 is provided to circulate operating gas through a closed fluid circuit including the cryopump 10. The compressor unit collects operating gas from the cryopump 10, compresses the gas, and delivers the gas again to the cryopump 10. The compressor 52 is configured to include a compressor main body 140 for raising the pressure of gas, a low pressure pipe 142 for supplying low pressure gas, supplied from the outside, to the compressor main body 140, and a high pressure pipe 144 for delivering high pressure gas compressed by the compressor main body 140.

The compressor 52 receives gas returned from the cryopump 10 by the intake port 146, and the operating gas is delivered to the low pressure pipe 142, accordingly. The intake port 146 is provided on a housing of the compressor 52 at an end of the low pressure pipe 142. The low pressure pipe 142 connects the intake port 146 and an intake opening of the compressor main body 140.

The low pressure pipe 142 comprises at its middle a storage tank 150 as a volume for eliminating pulsation included in returned gas. The storage tank 150 is provided between the intake port 146 and a branch to a bypass mechanism 152, which will be described later. The operating gas, with which the pulsation is eliminated in the storage tank 150, is supplied through the low pressure pipe 142 to the compressor main body 140. Inside the storage tank 150, a filter for removing unnecessary particles, etc. from gas may be provided. Between the storage tank 150 and the intake port 146, a receiving port and a pipe for replenishing operating gas from the outside may be connected.

The compressor main body 140 is, for example, a scroll pump or a rotary pump, and performs a function of raising the pressure of gas taken in. The compressor main body 140 sends pressurized operating gas to the high pressure pipe 144. The compressor main body 140 is configured to cool by using oil, and an oil cooling pipe that circulates oil is provided in association with the compressor main body 140. Thereby, the pressurized operating gas is sent to the high pressure pipe 144, while the oil is mixed in with the operating gas to some extent.

Therefore, at the middle of the high pressure pipe 144, an oil separator 154 is provided. Oil separated from operating gas by the oil separator 154 may be returned to the low pressure pipe 142, and may be returned to the compressor main body 140 through the low pressure pipe 142.

A relief valve for releasing excessive high pressure gas may be provided in the oil separator 154.

At the middle of the high pressure pipe 144 that connects the compressor main body 140 and the oil separator 154, a heat exchanger 145 for cooling high pressure operating gas delivered from the compressor main body 140 is provided. The heat exchanger 145 cools the operating gas by, for example, coolant water (shown by dashed lines). The coolant water may be also used for cooling the oil that cools the compressor main body 140. In the high pressure pipe 144, at least at one of the upstream or the downstream of the heat exchanger, a temperature sensor 153 for measuring the temperature of operating gas may be provided.

Two routes are provided to connect the compressor main body 140 and the oil separator 154. More specifically, a main flow passage 147 that passes through the heat exchanger 145 and a bypass flow passage 149 that circumvents the heat exchanger 145 are provided. The bypass flow passage 149 branches from the main flow passage 147 upstream from the heat exchanger 145 (downstream from the compressor main body 140), and merges with the main flow passage 147 downstream from the heat exchanger 145 (upstream from the oil separator 154).

A three-way valve 151 is provided at the merging point of the main flow passage 147 and the bypass flow passage 149. By switching the three-way valve 151, the flow passages of operating gas can be switched to one of the main flow passage 147 and the bypass flow passage 149. The three-way valve 151 may be replaced by another similar flow passage structure. For example, the switch between the main flow passage 147 and the bypass flow passage 149 may be allowed by providing a two-port valve for each of the main flow passage 147 and the bypass flow passage 149.

The operating gas that has passed through the oil separator 154 is sent to an adsorber 156 through the high pressure pipe 144. The adsorber 156 is provided for removing contaminants that have not been removed, for example by contaminant removing means provided on a flow passage, such as the filter in the storage tank 150, the oil separator 154, or the like. The adsorber 156 removes, for example, evaporated oil by adsorption.

The supply port 148 is provided on the housing of the compressor 52 at an end of the high pressure pipe 144. More specifically, the high pressure pipe 144 connects the compressor main body 140 and the supply port 148, and at the middle thereof, the heat exchanger 145, the oil separator 154, and the adsorber 156 are provided. The operating gas that has passed through the adsorber 156 is delivered to the cryopump 10 through the supply port 148.

The compressor 52 comprises the bypass mechanism 152 provided with a bypass pipe 158 that connects between the low pressure pipe 142 and the high pressure pipe 144.

In the exemplary embodiment shown in the figure, the bypass pipe 158 branches from the low pressure pipe 142 at a location between the storage tank 150 and the compressor main body 140. Further, the bypass pipe 158 branches from the high pressure pipe 144 at a location between the oil separator 154 and the adsorber 156.

The bypass mechanism 152 comprises a control valve for controlling the flux of operating gas that is not delivered to the cryopump 10 and flows around from the high pressure pipe 144 to the low pressure pipe 142. In the exemplary embodiment shown in the figure, a first control valve 160 and a second control valve 162 are provided in parallel at the middle of the bypass pipe 158. According to an exemplary embodiment, the first control valve 160 is a normally opened type solenoid valve, and the second control valve 162 is a normally closed type solenoid valve.

The first control valve 160 is provided for pressure equalization when operation is stopped. The second control valve 162 is used as a flow control valve of the bypass pipe 158.

The compressor 52 comprises a first pressure sensor 164 for measuring the pressure of return gas returned from the cryopump 10 and a second pressure sensor 166 for measuring the pressure of supply gas to be delivered to the cryopump 10. The first pressure sensor 164 is installed, for example in the storage tank 150 and measures the pressure of return gas, of which the pulsation is eliminated in the storage tank 150. The second pressure sensor 166 is provided, for example, between the oil separator 154 and the adsorber 156.

An explanation on the operations of the cryopump 10 with the aforementioned configuration will be given below. When activating the cryopump 10, the inside of the cryopump housing 30 is first roughly evacuated to approximately 1 Pa by using a rough pump 73 through the rough valve 72 before starting operation. The pressure is measured by the pressure sensor 54. Thereafter, the cryopump 10 is operated. By driving the refrigerator 50 under the control of the control unit 20, the first cooling stage 13 and the second cooling stage 14 are cooled, thereby the radiation shield 40, the baffle 62, and the cryopanel 60, which are thermally connected to the stages, are also cooled.

The cooled baffle 62 cools the gas molecules flowing from the vacuum chamber into the cryopump 10 so that a gas whose vapor pressure is sufficiently low at the cooling temperature (e.g., water vapor or the like) will be condensed and pumped on the surface of the baffle 62. A gas whose vapor pressure is not sufficiently low at the cooling temperature of the baffle 62 passes through the baffle 62 and enters inside of the radiation shield 40. Of the gas molecules that have been entered, a gas whose vapor pressure is sufficiently low at the cooling temperature of the cryopanel 60 will be condensed and pumped on the surface of the cryopanel 60. A gas whose vapor pressure is not sufficiently low at the cooling temperature (e.g., hydrogen or the like) is adsorbed and pumped by an adsorbent, which is adhered to the surface of the cryopanel 60 and cooled. In this way, the cryopump 10 can attain a desired degree of vacuum in the vacuum chamber to which the cryopump is mounted.

As pumping operation continues, gas is accumulated in the cryopump 10. In order to discharge the accumulated gas to the outside, a regeneration of the cryopump 10 is executed if a predetermined time period has been passed after starting the pumping operation or if a predetermined condition for starting the regeneration is satisfied. A regeneration procedure includes a heating process, an discharging process, and a cooling process.

The regeneration procedure of the cryopump 10 is controlled, for example, by the control unit 20. The control unit 20 determines whether or not the predetermined condition for starting the regeneration is satisfied, and in case that the condition is satisfied, starts to regenerate the pump. In this case, the control unit 20 stops the cooling operation of the refrigerator 50 for cooling the cryopanels and starts the heating operation, more specifically rapid heating operation, of the refrigerator 50. In case that the condition is not satisfied, the control unit 20 does not start the regeneration and, for example, continues vacuum pumping operation.

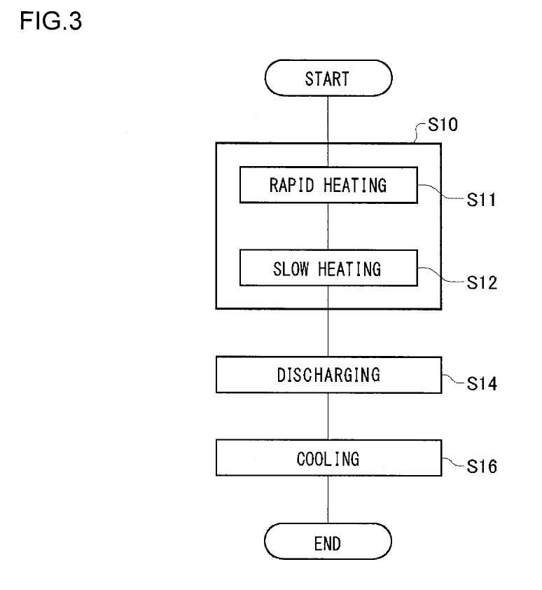

FIG. 3 shows a flowchart for illustrating a regeneration method according to an exemplary embodiment of the present invention. The regeneration procedure includes a heating process or step for heating the cryopump 10 to a regeneration temperature, which is higher than the temperature of the cryopanels during pumping operation. The exemplary regeneration process shown in FIG. 3 is so-called, full regeneration. The full regeneration regenerates all cryopanels including the low temperature cryopanel 60 and the baffle 62. The cryopanels are heated from a cooling temperature for vacuum pumping operation to a regeneration temperature, for example near ambient temperature (for example, about 300 K).

The heating process includes reverse-rotation heating. According to an exemplary embodiment, the reverse-rotation heating differentiates timings of intake and discharge of operating gas from those of the cooling operation so as to cause adiabatic compression to the operating gas by rotating the rotary valve in the refrigerator 50 in the reverse direction from that of the cooling operation. Compression heat obtained in this manner heats the cryopanels.

As shown in FIG. 3, according to an exemplary embodiment, the heating step includes rapid heating (S11) and slow heating (S12). The rapid heating heats the cryopanels at relatively high-speed from a cooling temperature of the cryopanel during the cooling operation to a threshold temperature for switching the heating speed. The slow heating heats the cryopanels at speed lower than that of the rapid heating from the threshold temperature for switching the heating speed to the regeneration temperature. The threshold temperature for switching the heating speed is, for example a temperature selected from a temperature range from 200 K to 250 K. It should be noted that the heating in two phases in the manner described above is not necessarily required. The cryopanels may be heated at a constant temperature rising speed, or may be heated by a heating process having more than two phases each of which a respective temperature rising speed is assigned to.

During the heating process, the control unit 20 controls the valve drive motor 16 so as to rotate at higher speed during the rapid heating than the speed thereof during the slow heating. During the rapid heating, the control unit 20 determines whether or not a measured value of the cryopanel temperature reaches the threshold temperature for switching the heating speed. The control unit 20 continues rapid heating until the measured value reaches the threshold temperature, and switches from the rapid heating to the slow heating in case that the measured value reaches the threshold temperature. During the slow heating, the control unit 20 determines whether or not a measured value of the cryopanel temperature reaches the regeneration temperature. The control unit 20 continues the slow heating until the measured value reaches the regeneration temperature, and completes the heating process and starts the subsequent process, i.e., discharging step in case that the measured value reaches the regeneration temperature.

The discharging step discharges gas, which is re-evaporated from the surface of the cryopanels, to the outside of the cryopump 10 (S14). The re-evaporated gas is discharged outside, for example, via the exhaust line 80, or by using the rough pump 73. The re-evaporated gas is exhausted from the cryopump 10 with purge gas that is infused as necessary. During the discharging step, the heating operation of the refrigerator 50 may be continued, or the operation of the refrigerator 50 may be stopped. The control unit 20 determines whether or not the exhaustion of gas is completed, for example, on the basis of a pressure value measured inside the cryopump 10. For example, during the pressure inside the cryopump 10 is in excess of a predetermined threshold value, the control unit 20 continues the discharging step. In case the pressure value falls below the threshold value, the control unit 20 completes the discharging step and starts the cooling step.

The cooling step re-cools the cryopanels in order to restart the vacuum pumping operation (S16). The cooling operation of the refrigerator 50 is started. The control unit 20 determines whether or not a measured value of the cryopanel temperature reaches a cryopanel cooling temperature for the vacuum pumping operation. The control unit 20 continues the cooling step until the measured value reaches the cryopanel cooling temperature, and completes the cooling step in case that the measured value reaches the cooling temperature. In this manner, the regeneration procedure is completed. The vacuum pumping operation of the cryopump 10 is restarted.

According to an exemplary embodiment of the present invention, the heating process or step for heating the cryopanels includes raising the temperature of operating gas to be supplied by the compressor 52 to the refrigerator 50 for cooling the cryopanels than the temperature before the heating process or step. The cryopump system 100 raises the temperature of operating gas to be supplied during the heating operation of the refrigerator 50 than the temperature thereof during the cooling operation of the refrigerator 50. The temperature of the operating gas to be supplied is raised at least during the rapid heating. Alternatively, the temperature of the operating gas to be supplied is raised throughout the heating process. After the rapid heating is completed or the heating process is completed, and by the time when the cooling process is started, the temperature of operating gas to be supplied is set back to the original temperature level.

According to an exemplary embodiment, the cryopump system 100 raises the temperature of operating gas to be supplied to the refrigerator 50 by controlling the switching of flow passages in the compressor 52. The control unit 20 switches flow passages in the compressor 52 in accordance with the operation status of the refrigerator 50. The control unit 20 allows operation gas to flow through the main flow passage 147 that passes through the heat exchanger 145 in case that the refrigerator 50 runs the cooling operation, and allows operation gas to flow through the bypass flow passage 149 in case of the heating operation.

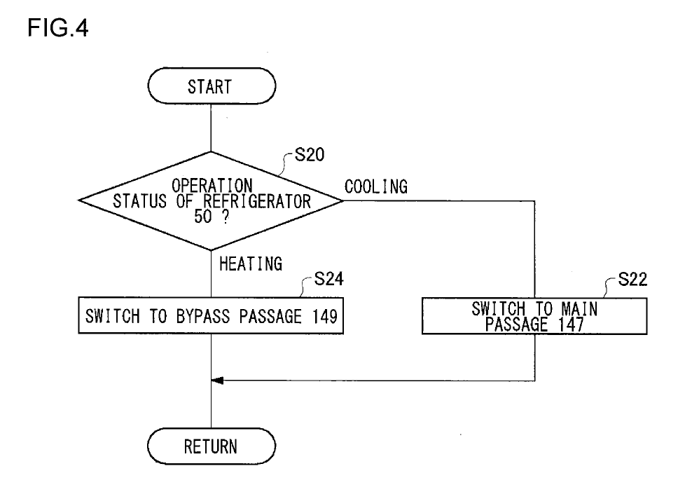

FIG. 4 shows a flowchart for illustrating flow passage switching control in the compressor 52 according to an exemplary embodiment of the present invention. This process is repeated by the control unit 20 at predetermined time intervals. First, the control unit 20 determines the operation status of the refrigerator 50 (S20). In case that the refrigerator 50 runs the cooling operation, the control unit 20 switches the three-way valve 151 so that operation gas passes through the main flow passage 147 in the compressor 52 (S22). In case that the refrigerator 50 ran the cooling operation at the determination made previous time, the control unit 20 continues the state where operating gas passes through the main flow passage 147.

On the other hand, in case that the refrigerator 50 runs the heating operation, the control unit 20 switches the three-way valve 151 so that operation gas passes through the bypass flow passage 149 in the compressor 52 (S24). In case that the refrigerator 50 ran the heating operation at the determination made previous time, the control unit 20 continues the state where operating gas passes through the bypass flow passage 149. In case that the operation of the refrigerator 50 is at a halt, the control unit 20 may not change the state of the three-way valve 151 and may continue the state.

As described above, the control unit 20 may switch the three-way valve 151 so that operation gas passes through the bypass flow passage 149 in the compressor 52 only during the execution of rapid heating. Alternatively, the three-way valve 151 may be switched so that the operation gas passes through the bypass flow passage 149 until the completion of the heating step or the completion of the discharging step. The control unit 20 switches the three-way valve 151 so that the route of operation gas is set back to the main flow passage 147 by the time when starting the cooling process.

By the switching operation of the three-way valve 151 in this manner, on one hand, operation gas passes through the main flow passage 147, i.e., through the heat exchanger 145 during the cooling operation, and on the other hand, operation gas passes through the bypass flow passage 149 without passing through the heat exchanger 145 during the heating operation. Therefore, operating gas is cooled by the heat exchanger 145 and the cooled operating gas is supplied to the refrigerator 50 during the cooling operation. On the other hand, since operating gas does not pass through the heat exchanger 145 during the heating operation, the operating gas at a high temperature as a result of compression heat given in the compressor main body 140 is supplied to the refrigerator 50 without being cooled.

The control unit 20 may reset the flow passage of operating gas from the bypass flow passage 149 to the main flow passage 147 on the basis of a value measured by the temperature sensor of the cryopump system 100. For example, the control unit 20 may switch from the bypass flow passage 149 to the main flow passage 147 in case that the temperature of operating gas to be supplied to the refrigerator 50 is predicted to be in excess of a predetermined temperature on the basis of a temperature measured by the temperature sensor 153. The predetermined temperature may be, for example, the regeneration temperature described above. In this manner, a situation where operating gas at an excessively high temperature is supplied to the refrigerator 50 can be avoided.

According to an exemplary embodiment of the present invention, operating gas at a comparatively high temperature can be supplied to the refrigerator 50 during its heating operation. Therefore, the heating of cryopanels can be expedited. Therefore, heating time in regeneration process of cryopanels can be reduced, thus time required for regeneration can be reduced. High temperature gas can be supplied to the refrigerator 50 by simple operation, i.e., switching of flow passages in the compressor 52, and by utilizing heat to be exhausted to the heat exchanger 145 without additional heating of operating gas. Thus, the embodiment excels in terms of energy conservation.

Given above is an explanation based on the exemplary embodiment. The exemplary embodiment described above is intended to be illustrative only and it will be obvious to those skilled in the art that various modifications could be developed and that such modifications are also within the scope of the present invention.

For example, in order to raise the temperature of operating gas to be supplied, the cooling capability of the heat exchanger 145 may be lowered during the heating process instead of the installation of the bypass flow passage 149 and the switch of flow passages. For example, the flux of refrigerant (coolant water) of the heat exchanger 145 may be reduced, or the temperature of the coolant water may be raised. Alternatively, a main flow passage that exchanges heat with operating gas and a bypass flow passage that does not exchange heat may be provided in a refrigerant flow passage of the heat exchanger 145, and the main flow passage and the bypass flow passage may be switched in accordance with the operation status of the refrigerator 50 in a similar manner as that of the exemplary embodiment described above.

Although the main flow passage 147 and the bypass flow passage 149 are selectively used for allowing operating gas to flow according to the exemplary embodiment described above, the scope of the invention is not limited to this example. By adjusting the flow ratio between the main flow passage 147 and the bypass flow passage 149, the temperature of operating gas may be adjusted to some extent.

It should be understood that the invention is not limited to the above-described embodiment, but may be modified into various forms on the basis of the spirit of the invention. Additionally, the modifications are included in the scope of the invention.

Priority is claimed to Japanese Patent Application No. 2011-87169, filed Apr. 11, 2011, the entire content of which is incorporated herein by reference.

What is claimed is:

1. A cryopump system comprising:
a cryopump comprising a refrigerator configured to execute cooling operation for cooling a cryopanel and heating operation for regenerating the cryopanel; and
a compressor configured to supply operating gas to the refrigerator, wherein
the cryopump system is configured to raise an operating gas temperature in the compressor during the heating operation than that during the cooling operation.

2. The cryopump system according to claim 1 further comprising a control unit configured to control the compressor, wherein
the compressor includes a heat exchanger that cools operating gas to be supplied to the refrigerator, and a bypass passage that circumvents the heat exchanger, and
the control unit switches, in accordance with the operation status of the refrigerator, between a flow passage passing through the heat exchanger and a flow passage passing through the bypass passage.

3. The cryopump system according to claim 1, wherein
the heating operation includes: rapid heating that heats the cryopanel at high-speed from a cooling temperature to a threshold temperature for switching heating speed; and slow heating that heats the cryopanel at speed lower than that of the rapid heating from the threshold temperature to a regeneration temperature, and
the gas temperature is raised at least during the rapid heating.

4. An operating gas compressor for a cryopump or a refrigerator, wherein
the compressor is configured to raise the temperature of operating gas to be supplied during heating operation than the temperature thereof during cooling operation of the cryopump or the refrigerator.

5. A regeneration method for a cryopump, comprising:
heating a cryopanel, wherein the heating comprises raising an operating gas temperature for a refrigerator in the cryopump than that before the heating.
